(19) United States
(12) Patent Application Publication
(10) Pub. No.: US 2021/0248400 A1
(43) Pub. Date: Aug. 12, 2021

(54) Operator Behavior Recognition System

(71) Applicant: 5DT, Inc., Orlando, FL (US)

(72) Inventor: Jaco Cronje, Zwavelpoort (SA)

(21) Appl. No.: 17/257,005

(22) PCT Filed: Oct. 22, 2019
(86) PCT No.: PCT/IB19/58983

§ 371 Date: Dec. 30, 2020

Related U.S. Application Data
(60) Provisional application No. 62/748,593, filed on Oct. 22, 2018.

(51) Int. Cl. G06K 9/00; G06K 9/62; G06N 3/04; G06N 3/08

(52) U.S. Cl. CPC G06K 9/00845; G06K 9/00281; G06K 9/00355; G06K 9/00302; G06N 3/084; G06K 9/6262; G06K 9/6256; G06N 3/0454; G06K 9/6292

(57) ABSTRACT

An operator behavior recognition system comprising hardware including at least one processor, a data storage facility in communication with the processor and input/output interfaces in communication with the processor, the hardware being configured to implement a set of convolutional neural networks (CNNs) including: an object detection group into which at least one image is received from an image source for detecting at least one object in the image and to delineate the object from the image for further processing, at least one of the objects being detected being a face of a person; a facial features extraction group into which the image of the person's face is received and from which facial features from the person's face are extracted; and a classifier group which assess the facial features received from the facial feature extraction group in combination with objects detected by the object detection group to classify predefined operator behaviors.

### CROSS-REFERENCE TO RELATED APPLICATION(S) INFORMATION

The present application is a U.S. national stage patent application, pursuant to 35 U.S.C. § 371, of PCT International Application No.: PCT/IB2019/058983, filed Oct. 22, 2019, published as WO2020/084467A1, which claims priority to U.S. provisional patent application No. 62/748,593, filed Oct. 22, 2018, the contents of all of which are hereby incorporated by reference in their entirety.

### TECHNICAL FIELD

This invention relates to an operator behavior recognition system and a machine-implemented method for automated recognition of operator behavior.

### BACKGROUND

Distracted operators are one of the main causes of serious incidents and accidents.

The inventor identified a need to recognize operator behavior when operating a vehicle or machinery and to generate an alarm to correct such operator behavior, thereby to reduce or prevent incidents and accidents related to operator distraction.

More specifically, the inventor identified a need to address the problem of mobile device usage when operating a vehicle or machinery. Mobile device usage includes the general use of a mobile device or electronic device, such as a two way radio, that can distract the operator from his duties. It includes but is not limited to mobile device use such as texting, talking, reading, watching videos and the like.

It is an object of the invention to recognize certain undesirable behavior of an operator such as detecting a mobile device use event and to generate an alarm to alert the operator or to alert a remote system.

Prior inventions and disclosures described below address certain aspects of the proposed solution, but do not provide a solution to the problem of distracted operators.

Conduct inference apparatus (U.S. Pat. No. 8,045,758, 2011) uses the body pose to detect a hand moving to the ear and assumes mobile device usage when it is detected. This disclosure assumes that an object such as a mobile device is present at the body parts (hands) tracked and therefore will generate false detections when the operator perform actions such as scratching the head or ear. This disclosure is also unable to distinguish between different objects that the operator may have in his/her hand. The invention detects a mobile phone and is trained on a data-set with negative samples (hands near the face without a mobile device). The invention will not generate similar false detections. The invention is also capable of distinguishing between different objects in the hand of the operator.

Action estimating apparatus, method for estimating occupant's action, and program (U.S. Pat. No. 8,284,252, 2012) published by the same authors, uses body pose method to detect the position of the arm and matches it to predetermined positions of talking on a mobile device. This disclosure also make use of only the tracked positions of body parts such as the hands, elbow and shoulder. The disclosure does not detect an object from the image and only classify mobile device usage based on movements of the operator. The invention detects objects such as the mobile device, tracks body part locations and classifies mobile device usage by movement of the object over time with the LSTM recurrent neural network.

Real-time multiclass driver action recognition using random forests (U.S. Pat. No. 9,501,693, 2016) uses 3-dimensional images together with random forest classifiers to predict driver actions and mobile device usage. This disclosure use only a single image to predict driver actions. Therefore, no temporal information is used. The disclosure is limited to random forest classifiers, while the invention is not limited and make use of state-of-the-art convolutional neural networks. The invention use temporal information from multiple images in sequence with the LSTM recurrent neural network and the ensemble of classifiers enable a more accurate prediction model than a single image random forest model as discussed in the disclosure.

Machine learning approach for detecting mobile phone usage by a driver (U.S. Pat. No. 9,721,173, 2017), detects mobile device usage from outside the vehicle using a frontal view. Body pose detection and CNNs are not used. Instead, hand-crafted features such as Scale-Invariant Feature Transform (SIFT), Histogram of Gradients (HoG) and Successive Mean Quantization Transform (SMQT) are used. In this disclosure hand-crafted features are used which is not as accurate as CNNs. The disclosure is also limited to frontal views from outside the vehicle. This disclosure make no use of temporal information. The invention is not limited to specific viewing positions and works from outside of inside the vehicle.

Method for detecting driver cell phone usage from side-view images (U.S. Pat. No. 9,842,266, 2017) was published by the same authors in which additional side-view images were used instead of only frontal images. Similar to the previous disclosure, hand-crafted features are used and no temporal information is used which makes the invention more accurate. This disclosure use very specific side-view images of vehicles and will fail when the windows are tinted.

### SUMMARY OF THE DISCLOSURE

According to a first aspect of the invention, there is provided an operator behavior recognition system comprising hardware including at least one processor, a data storage facility in communication with the processor and input/output interfaces in communication with the processor, the hardware being configured to implement a set of convolutional neural networks (CNNs) including:

an object detection group into which at least one image is received from an image source for detecting at least one object in the image and to delineate the object from the image for further processing, at least one of the objects being detected being a face of a person;

a facial features extraction group into which the image of the person's face is received and from which facial features from the person's face are extracted; and

a classifier group which assess the facial features received from the facial feature extraction group in combination with objects detected by the object detection group to classify predefined operator behaviors.

The interpretation of the words ‘operator behavior’ is equivalent to ‘operator actions’. The interpretation of the words ‘operator’, ‘occupant’ and ‘observer’ is equivalent. The interpretation of the words “safety belt” and “seat belt” is also equivalent.

The object detection group may comprise a detection CNN trained to detect objects in an image and a region determination group to delineate the detected object from the rest of the image. The object detection group may comprise one CNN per object or may comprise one CNN for a number of objects.

The object detection group may be pre-trained to recognize any one or more of a hand of a person, an operator, predefined components/controls of a machine and a mobile device. For example the image of the operator may include the image portion showing the person with its limbs visible in the image. The image of the face of a person may include the image portion showing only the person's face in the image. The image of the predefined components/controls of the machine may include the image portion or image portions including machine components/controls, such as a steering wheel, safety components (i.e. a safety belt), indicator arms, rear or side view mirrors, machine levers (i.e. a gear lever), or the like. The image of a mobile device may include the image portion in which a mobile device, such as a mobile telephone is visible.

It is to be appreciated that the object detection group may generate separate images each of which is a subset of the at least one image received from the image source.

The facial features extraction group may be pre-trained to recognize predefined facial expression of a person. In particular, the facial features extraction group may be pre-trained to extract the face pose, the gaze direction, the mouth state, and the like from the person's face. In particular, the facial expression of a person is determined by assessing the location of the person's eyes, mouth, nose, and jaw. The mouth state is determined by assessing if the person's mouth is open or closed.

The classifier group may be pre-trained with classifiers which takes as input the objects detected from the object detection group in combination with facial features extracted from the facial feature extraction group to classify the behavior of a person. In one embodiment, to determine if a person is talking on a mobile device, the classifier may use the position of the hand of a person in relation to the position of a mobile device in relation to the position of a face of a person in combination with the mouth state of a person to determine of a person is talking on a mobile device. The classifier group may include classification techniques such as support vector machines (SVMs), neural networks, boosted classification trees, or other machine learning classifiers.

In addition the classifier group may include two additional classifiers being:

a single image CNN of the operator;

a single image CNN of the operator in combination with a long-term-short-term memory (LSTM) recurrent network, which keeps a memory of a series of previous images.

The classifier group may include an ensemble function to ensemble the outputs of the classifiers together with the output of the single image CNN of the operator together with the combination of the single image CNN and the LSTM recurrent network by a weighted sum of the three classifiers where the weights are determined by optimizing the weights on the training dataset. The ensem bled output from the classifiers is used to determine the operator behavior.

It is to be appreciated that the set of CNNs in the object detection group, the facial feature extraction group and the classifier group may be implemented on a single set of hardware or on multiple sets of hardware.

According to another aspect of the invention, there is provided a machine-implemented method for automated recognition of operator behavior, which includes

receiving onto processing hardware at least one image from an image source;

processing the at least one image by an object detection group to detect at least one object in the image and to delineate the object from the image for further processing, at least one of the objects being detected being a face of a person;

processing a face object of a person by means of a facial features extraction group to extract facial features from the person's face; and

processing an output from the object detection group and the facial features extraction group by means of a classifier group to assess the facial features received from the facial feature extraction group in combination with objects detected by the object detection group to classify predefined operator behaviors.

The step of processing the at least one image by an object detection group may include detecting objects in an image and delineating detected objects from the rest of the image.

The step of processing the at least one image by an object detection group may include recognizing any one or more of a hand of a person, an operator, predefined components/controls of a machine and a mobile device.

The step of processing the at least one image by an object detection group may include generating separate images each of which is a subset of the at least one image received from the image source.

The step of processing a face object of a person by means of a facial features extraction group may include recognizing a predefined facial expressions of a person. In particular, the step of processing a face object of a person by means of a facial features extraction group may include extracting from an image the face pose, the gaze direction, the mouth state, and the like from the person's face. In particular, the step of processing a face object of a person by means of a facial features extraction group may include determining the location of the person's eyes, mouth, nose, and jaw. The step of processing a face object of a person by means of a facial features extraction group may include determining if the person's mouth is open or closed.

The step of processing an output from the object detection group and the facial features extraction group by means of a classifier group may include taking as input the objects detected from the object detection group in combination with facial features extracted from the facial feature extraction group to classify the behavior of a person. In particular the step of processing an output from the object detection group and the facial features extraction group by means of a classifier group may include determining if a person is talking on a mobile device by using the position of the hand of a person in relation to the position of a mobile device in relation to the position of a face of a person in combination with the mouth state of a person. The step of processing an output from the object detection group and the facial features extraction group by means of a classifier group may include implementing classification techniques such as support vector machines (SVMs), neural networks, boosted classification trees, or other machine learning classifiers.

In addition the step of processing an output from the object detection group and the facial features extraction group by means of a classifier group may include using two additional classifiers being:

a single image CNN of the operator;

a single image CNN of the operator in combination with a long-term-short-term memory (LSTM) recurrent network, which keeps a memory of a series of previous images.

The step of processing an output from the object detection group and the facial features extraction group by means of a classifier group may include ensembling the outputs of the classifiers together with the output of the single image CNN of the operator together with the combination of the single image CNN and the LSTM recurrent network by a weighted sum of the three classifiers where the weights are determined by optimizing the weights on the training dataset. The step of processing an output from the object detection group and the facial features extraction group by means of a classifier group may include using the output from the classifiers to determine the operator behavior.

The invention extends to a machine-implemented method for training an operator behavior recognition system as described above, the method including:

providing a training database of input images and desired outputs;

dividing the training database into a training subset and a validation subset with no overlap between the training subset and the validation subset;

initializing the CNN model with its particular parameters;

setting network hyperparameters for the training;

processing the training data in an iterative manner until the epoch parameters are complied with; and

validating the trained CNN model until a predefined accuracy threshold is achieved.

The machine-implemented method for training an operator behavior recognition system may include training any one or more of an object detection CNN as described, a facial features extraction CNN as described and a classifier CNN as described, each of which is provided with a training database and a relevant CNN to be trained.

The invention is now described, by way of non-limiting example, with reference to the accompanying drawings.

### BRIEF DESCRIPTION OF THE DRAWINGS

In the drawings(s):

FIG. 1 shows an example image captured by a camera of the operator behavior recognition system hardware of FIG. 4;

FIG. 2 shows a process diagram of the method in accordance with one aspect of the invention;

FIG. 3 shows a Convolutional Neural Network (CNN) training process diagram; and

FIG. 4 shows an example of operator behavior recognition system hardware architecture in accordance with one aspect of the invention.

### DETAILED DESCRIPTION

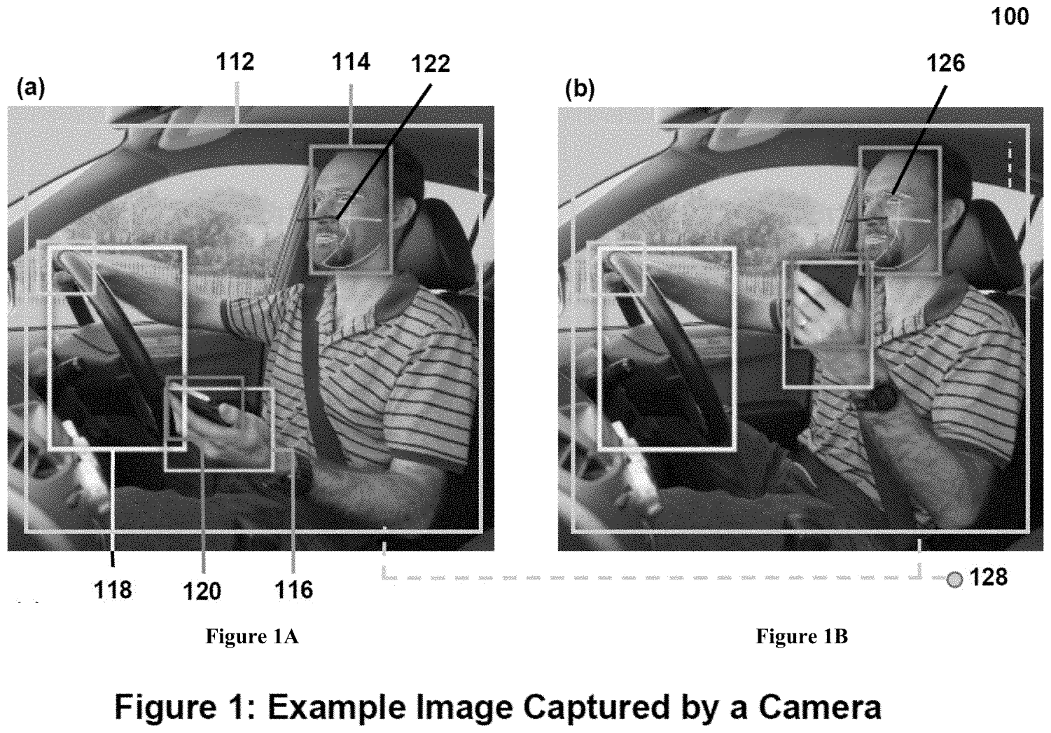

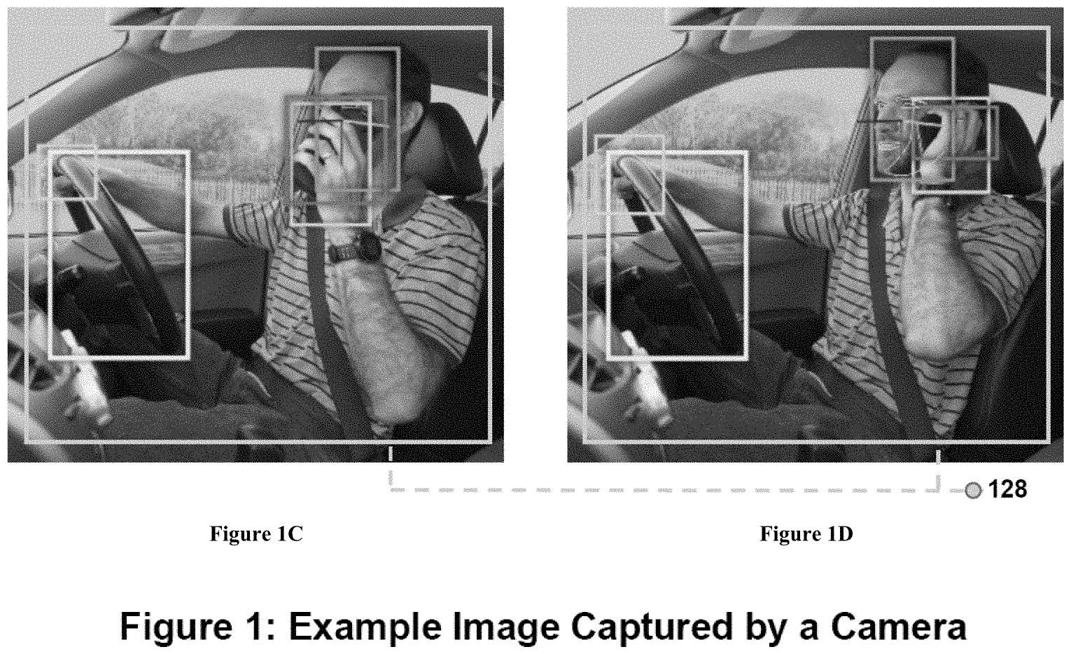

FIG. 1 shows an example image (100) captured by a camera that monitors the operator in a machine-implemented method for automated recognition of operator behavior. The system detects multiple objects of interest such as the operator (or operators) (112) of the vehicle or machine, face (114) of the operator, facial features (126) of the operator's face, pose (gaze direction) (122) of the operator, operator's hands (116), mobile device (120) and vehicle or machine controls (such as, but not limited to, a steering wheel) (118). The facial features (126) include the eye and mouth features. The objects are detected and tracked over time (128) across multiple frames (a), (b), (c) and (d).

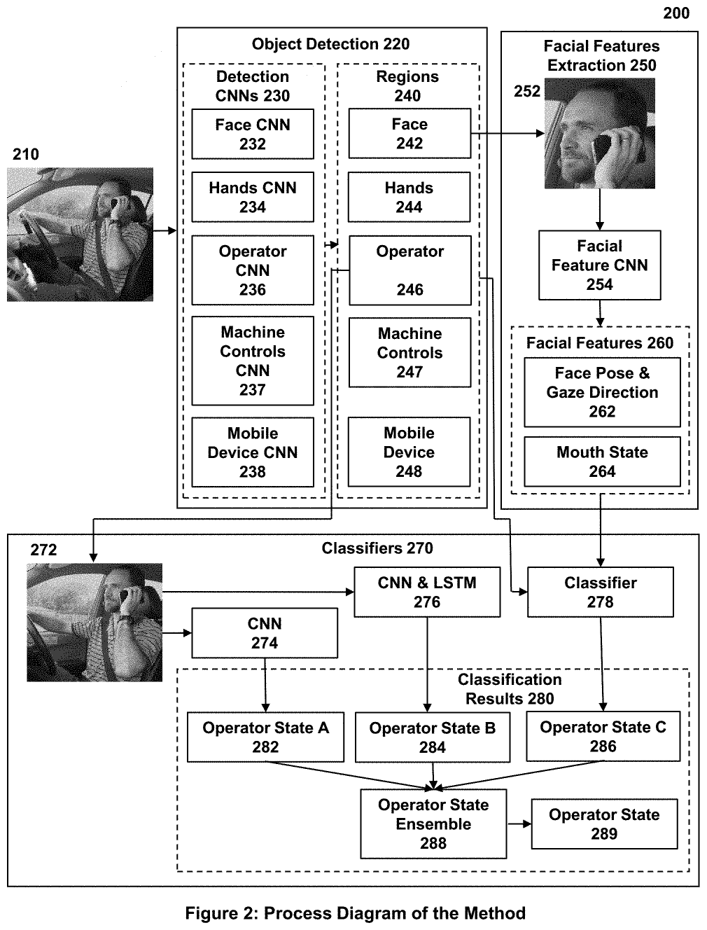

FIG. 2 shows a flow diagram illustrating a machine-implemented method (200) for automated recognition of operator behavior in accordance with one aspect of the invention. The image captured by the image capturing device is illustrated by (210).

Detection CNNs (230) are used to detect the regions (240) of objects of interest and is further described in paragraph 1. The image region containing the operator face (252) is cropped from the input image (210) from which facial features are extracted as described in paragraph 2. Different classifiers (270) use the image data, objects detected and facial features to classify the behavior of the operator. The classifiers are described in paragraph 3. The results of all the classifiers are ensembled as described in paragraph 4. The machine learning process is described in paragraph 5.

### 1. Object Detection (220)

A detection CNN takes an image as input and outputs the bounding region in 2-dimensional image coordinates for each class detected. Class refers to the type of the object detected, such as face, hands and mobile device for example. Standard object detector CNN architectures exist such as You Only Look Once (YOLO) [9] and Single Shot Detector (SSD) [10].

The input image (210) is subjected to all the detection CNNs. Multiple detection CNNs (230) can be used (232, 234, 236, 237 and 238). Each detection CNN (230) can output the region (240) of multiple detected objects. The face detection CNN (232) detects face bounding regions and outputs the region (242) of each face detected. The hands detection CNN (234) detects hand locations (244), while the operator detection CNN (236) detects the bounding region (246) of the operator. The machine controls CNN (237) detects machine controls locations (247). The mobile device CNN (238) detects mobile device locations (248).

### 2. Facial Feature Extraction (250)

The extracted image region of the face (252) is used to determine the face pose and gaze direction (262) of the operator. Facial features include locations of important facial features, as well as face pose (gaze direction) (262). These facial features are the locations of the eyes, mouth, nose and jaw for example. The facial features (260), as well as the face pose (gaze direction) (262), are detected by using one or more facial feature CNNs (254). The mouth state (264) based on mouth features detected, is calculated to determine if the mouth is open or closed. The mouth state is an indicator whether the person is talking or not and is used to improve mobile device usage detection accuracy.

Gaze direction algorithms have been studied as can be seen in [11], [12], [13] and [14]. Facial features detection method using local binary features is described in [15], while a CNN approach was followed in [16].

### 3. Classifiers (270)

The operator behavior is estimated by using three independent classifiers (274), (276) and (278). The classifiers can be used on their own or together with the other classifiers in any combination to obtain classification results (280). The results of each classifier are merged by means of a weighted sum ensemble (288). Each classifier outputs the probability of the operator being busy using a mobile device for actions such as texting, talking, reading, watching videos and the like, on the device or operating normally. The outputs of each classifier are not limited to the mentioned behaviors.

Classifier (278) takes as input the detected object regions (240) provided by the detection CNNs (230) as well as features extracted by other means such as the estimated face pose and gaze direction (262) and mouth state (264). Classification techniques used for classifier (278) include, e.g., support vector machines (SVM), neural networks, boosted classification trees, or other machine learning classifier. This classifier considers the location of the hands of the operator and whether a mobile device is present. When a hand together with a mobile device is detected, the probability of mobile device usage increases. The mouth state indicates if the operator is having a conversation and increase the predicted probability of the mobile device use.

The image region of the operator (272) is cropped from the original input image (210) by using the detected region of the operator from (246). The classification CNN (274) is given this single image of the operator as input and outputs a probability list for each behavior. This classifier determines the behavior by only looking at a single image.

The classification CNN (276) also receives the operator image (272) as input but works together with a long-term-short-term memory (LSTM) recurrent network [17]. This classifier keeps a memory of previously seen images and uses that to determine the operator behavior with temporal features gathered over time. Typically, the movement of the hands towards the face and the operator looking at a mobile device will increase mobile device usage probabilities.

### 4. Ensemble of Results

Each of the classifiers (274, 276 and 278) mentioned before in paragraph 3 can be used as a mobile device usage classifier on its own. The accuracy of the classification is further improved by combining the classification results (282, 284 and 286) of all the classifiers. This process is called an ensemble (288) of results. The individual results are combined by a weighted sum where the weights are determined by optimizing the weights on the training dataset, to arrive at a final operator state (289). Initially, equal weights are assigned to each individual classifier. For each training sample in the training dataset, a final operator state is predicted by calculating the weighted sum of the classifier results based on the selected weights. The training error is determined by summing each sample error over the complete training dataset. The individual weights for each individual classifier is optimized such that the error over the training dataset is minimized. Optimization techniques are not limited, but techniques such as stochastic gradient descent and particle swarm optimization are used to simultaneously optimize all the weights. The goal of the objective function optimized is to minimize the classification error on the training dataset.

### 5. Training of Convolutional Neural Networks

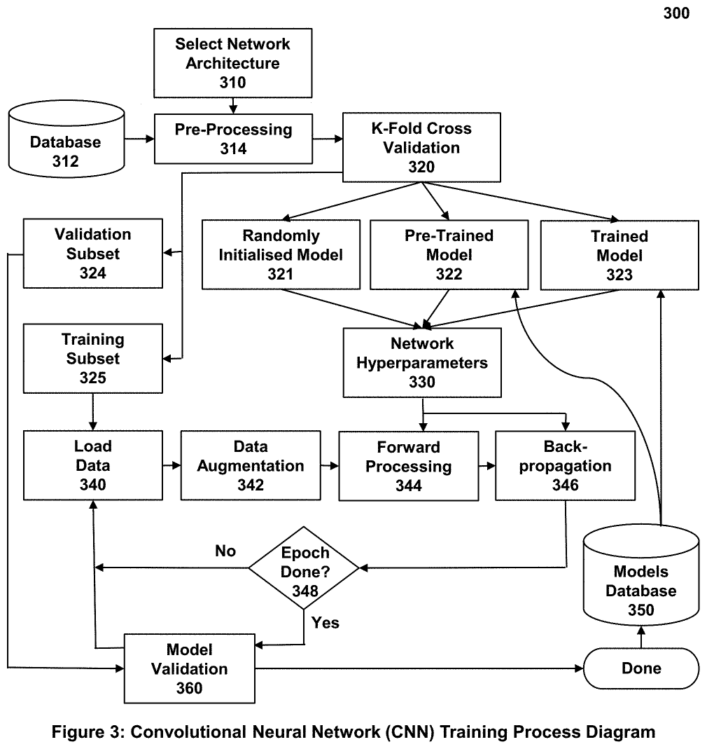

The process of training a CNN for classification or detection is illustrated in FIG. 3. The training database (312) contains the necessary input images and desired output to be learned by the CNN. An appropriate network architecture (310) is selected that fits the needs of the model to be trained. If a detection CNN is trained, a detection network architecture is selected. Similarly, a gaze direction network architecture is selected for a gaze direction CNN. Pre-processing of the data happens at (314) in which the resolution of the database images is resized to match the resolution of the selected network architecture. For LSTM networks, a stream of multiple images is created for training.

K-Fold Cross validation is configured in (320), where K is selected to be between for example 5 and 10. For each of the K folds, the pre-processed data from (314) is split into a training subset (325) and a validation subset (324). There is no overlap between the training and validation sets.

The CNN model to be trained is initialized in different ways. Random weights and bias initialization (321) is selected when the model is trained without any previous knowledge or trained models. A pre-trained model (322) can also be used for initialization, this method is known as transferred-learning. The pre-trained model (322) is a model previously trained on a totally different subject matter and the training performed will fine-tune the weights for the specific task. An already trained model (323) for the specific task is also used to initialize the model. In the case of (323) the model is also fine-tuned, and the learning rate of the training process expected is to be set at a low value.

The network hyperparameters (330) such as the learning rate, batch size and number of epochs are selected. An epoch is defined as a single iteration through all the images in the training set. The learning rate defines how fast the weights of the network is updated. The batch size hyperparameter determines the number of random samples to be selected. The iterative training process starts by loading training samples (340) from the training subset (325) selected in K-fold validation (320). Data augmentation (342) is applied to the batch of data by applying random transformations on the input such as but not limited to scaling, translation, rotation and color transformations. The input batch is passed through the network in the forward processing step (344) and the output compared with the expected results. The network weights are then adjusted by means of backpropagation (346) depending on the error between the expected results and the output of the forward processing step (344).

The process repeats until all the samples in the training set has been processed (Epoch Done′) (348). After every epoch, a model validation process (360) is used to validate how well the model learned to perform the specific task. Validation is performed on the validation subset (324). Once the validation error reaches an acceptable threshold or when the maximum number of epochs selected in (330) is reached, training stops. The weights of the network are stored in the models database (350).

### 6. Hardware Implementation

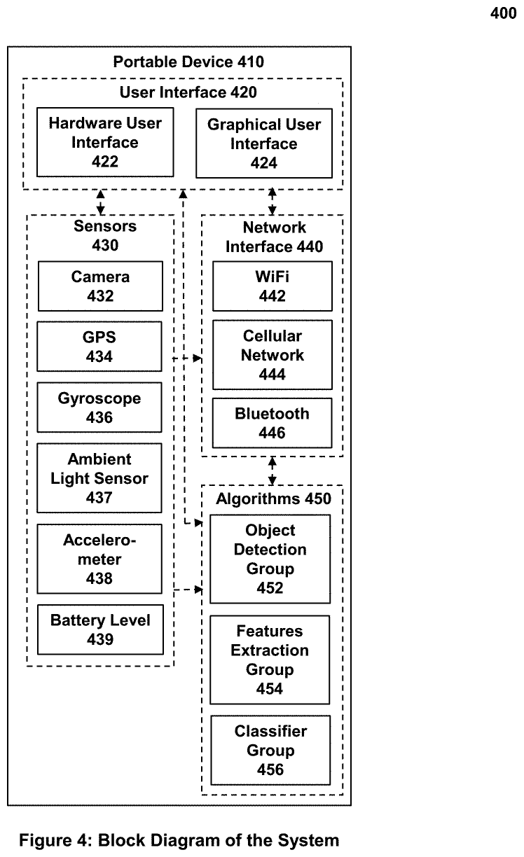

FIG. 4 shows an operator behavior recognition system (400) comprising hardware in the form of a portable device (410). The portable device (410) includes a processor (not shown), a data storage facility/memory (not shown) in communication with the processor and input/output interfaces in communication with the processor. The input/output interfaces are in the form of a user interface (UI) (420) that includes a hardware user interface (HUI) (422) and/or a graphical user interface (GUI) (424). The UI (420) is used to log in to the system, control it and view information collected by it.

The portable device (410) includes various sensors (430), such as a camera (432) for capturing images (such as, but not limited to visible and infrared (IR)), a global positioning system (GPS) (434), ambient light sensors (437), accelerometers (438), gyroscopes (436) and battery level (439) sensors. The sensors (430) may be built into the device (410) or connected to it externally using either a wired or wireless connection. The type and number of sensors used will vary depending on the nature of the functions that are to be performed.

The portable device (410) includes a network interface (440) which is used to communicate with external devices (not shown). The network interface (440) may use any implementation or communication protocol that allows communication between two or more devices. This includes, but is not limited to, Wi-Fi (442), cellular networks (GSM, HSPA, LTE) (444) and Bluetooth (446).

The processor (not shown) is configured to run algorithms (450) to implement a set of convolutional neural networks (CNNs) including:
an object detection group (452) into which at least one image is received from an image source for detecting at least one object in the image and to delineate the object from the image for further processing, at least one of the objects being detected being a face of a person;
a facial features extraction group (454) into which the image of the person's face is received and from which facial features from the person's face are extracted; and
a classifier group (456) which assess the facial features received from the facial feature extraction group in combination with objects detected by the object detection group to classify predefined operator behaviors.

The inventor is of the opinion that the invention provides a new system for recognizing operator behavior and a machine-implemented method for automated recognition of operator behavior.

The invention described herein provides the following advantages:
The operator under observation is not limited to the task of driving. The approach can be applied to any operator operating or observing machinery or other objects, such as, but not limited to:
   evaluation of drivers of trucks and cars;
   evaluation of operators of machines (such as, but not limited to, mining and construction machines);
   evaluation of pilots;
   evaluation of occupants of simulators;
   evaluation of participants of simulations;
   evaluation of operators viewing video walls or other objects;
   evaluation of operators/persons viewing objects in shops;
   evaluation of operators working in a mine, plant or factory;
   evaluation of occupants of self-driving vehicles or aircraft, taxis or ride-sharing vehicles.
State of the art, deep convolutional neural networks are used.
The system is trained with synthetic virtual data as well as real-world data. Therefore, the system is trained with data of dangerous situations that has been generated synthetically. This implies that the lives of people are not put at risk to generate real-world data of dangerous situations.
Feature-based, single-shot and multi-shot classifications are ensembled (combined) to create a more accurate model for behavior classification.

The principles described herein can be extended to provide the following additional features to the operator behavior recognition system and the machine-implemented method for automated recognition of operator behavior:
Drowsiness Detection
Eyes Off Road (EOR) Detection
Facial Recognition of Operators/Occupants
Safety Belt Detection
Mobile Device Usage Detection (including, but not limited to, talking and texting)
Hands Near Face (HNF) Detection
Personal Protective Equipment (PPE) Detection
Hours of Service Logging
Unauthorized Actions Detection (including, but not limited to, smoking, eating, drinking and makeup application)
Unauthorized Occupant Detection
Number of Occupants Detection
Mirror Check Detection
Cargo Monitoring
Unauthorized Object Detection (including, but not limited to, guns or knives)

### REFERENCES

[1] B. Yoshua, “Learning deep architectures for Al,” Foundations and trends in Machine Learning, vol. 2, pp. 1-127, 2009.
[2] Y. LeCun, Y. Bengio and G. Hinton, “Deep learning,” in Nature, 2015.
[3] Ishikawa, “Conduct inference apparatus”. U.S. Pat. No. 8,045,758, 25 Oct. 2011.
[4] Ishikawa, “Action estimating apparatus, method for estimating occupant's action, and program”. U.S. Pat. No. 8,284,252, 9 Sep. 2012.
[5] S. Fujimura, “Real-time multiclass driver action recognition using random forests”. U.S. Pat. No. 9,501,693, 22 Nov. 2016.
[6] B. Xu, R. Loce, T. Wade and P. Paul, “Machine learning approach for detecting mobile phone usage by a driver”. U.S. Pat. No. 9,721,173, 1 Aug. 2017.
[7] B. Orhan, A. Yusuf, L. Robert and P. Peter, “Method for detecting driver cell phone usage from side-view images”. U.S. Pat. No. 9,842,266, 12 Dec. 2017.
[8] C. Sek and K. Gregory, “Vision based alert system using portable device with camera”. U.S. Pat. No. 7,482,937, 27 Jan. 2009.
[9] J. Redmon, S. Divvala, R. Girshick and A. Farhadi, “You only look once: Unified, real-time object detection,” in Proceedings of the IEEE conference on computer vision and pattern recognition, 2016.
[10] W. Liu, D. Anguelov, D. Erhan, C. Szegedy, S. Reed, C.-Y. Fu and A. C. Berg, “Ssd: Single shot multibox detector,” in European conference on computer vision, 2016.
[11] F. Vicente, Z. Huang, X. Xiong, F. De la Torre, W. Zhang and D. Levi, “Driver gaze tracking and eyes off the road detection system,” IEEE Transactions on Intelligent Transportation Systems, vol. 16, no. 4, pp. 2014-2027, 2015.
[12] A. Kar and P. Corcoran, “A review and analysis of eye-gaze estimation systems, algorithms and performance evaluation methods in consumer platforms,” IEEE Access, vol. 5, pp. 16495-16519, 2017.
[13] Y. Wang, T. Zhao, X. Ding, J. Bian and X. Fu, “Head pose-free eye gaze prediction for driver attention study,” in Big Data and Smart Computing (BigComp), 2017 IEEE International Conference, 2017.
[14] A. Recasens, A. Khosla, C. Vondrick and A. Torralba, “Where are they looking?,” in Advances in Neural Information Processing Systems, 2015.
[15] S. Ren, X. Cao, Y. Wei and J. Sun, “Face alignment via regressing local binary features,” IEEE Transactions on Image Processing, vol. 25, no. 3, pp. 1233-1245, 2016.
[16] R. Ranjan, S. Sankaranarayanan, C. D. Castillo and R. Chellappa, “An all-in-one convolutional neural network for face analysis,” in Automatic Face and Gesture Recognition (FG 2017), 2017 12th IEEE International Conference, 2017.
[17] J. Donahue, A. Hendricks, S. Guadarrama, M. Rohrbach, S. Venugopalan, K. Saenko and T. Darrell, “Long-term recurrent convolutional networks for visual recognition and description,” in Proceedings of the IEEE conference on computer vision and pattern recognition, 2015.
[18] M. Babaeian, N. Bhardwaj, B. Esquivel and M. Mozumdar, “Real time driver drowsiness detection using a logistic-regression-based machine learning algorithm,” 2016 IEEE Green Energy and Systems Conference (IGSEC), pp. 1-6, November 2016.

1. An operator behavior recognition system comprising hardware including at least one processor, a data storage facility in communication with the processor and input/output interfaces in communication with the processor, the hardware being configured to implement a set of convolutional neural networks (CNNs) including:
an object detection group into which at least one image is received from an image source for detecting at least one object in the image and to delineate the object from the image for further processing, at least one of the objects being detected being a face of a person;
a facial features extraction group into which the image of the person's face is received and from which facial features from the person's face are extracted; and
a classifier group which assess the facial features received from the facial feature extraction group in combination with objects detected by the object detection group to classify predefined operator behaviors.

2. The operator behavior recognition system of claim 1, in which the object detection group comprises a detection CNN trained to detect objects in an image and a region determination group to delineate the detected object from the rest of the image.

3. The operator behavior recognition system of claim 2, in which the object detection group comprises any one of a single CNN per object or a single CNN for a number of objects.

4. The operator behavior recognition system of claim 3, in which the image of the operator includes the image portion showing any one of the person with its limbs visible in the image and showing only the person's face in the image.

5. The operator behavior recognition system of claim 3, in which the object detection group is pre-trained to recognize any one or more of a hand of a person, an operator, predefined components/controls of a machine and a mobile device in an image portion showing the person with its limbs visible in the image.

6. The operator behavior recognition system of claim 5, in which the object detection group generates separate images each of which is a subset of the at least one image received from the image source.

7. The operator behavior recognition system of claim 1, in which the facial features extraction group is pre-trained to recognize a predefined facial expression of a person.

8. The operator behavior recognition system of claim 7, in which the facial features extraction group is pre-trained to extract any one or more of a face pose, a gaze direction and a mouth state from the person's face.

9. The operator behavior recognition system of claim 8, in which the facial expression of a person is determined by assessing the location of the person's eyes, mouth, nose, and jaw.

10. The operator behavior recognition system of claim 9, in which the mouth state is determined by assessing if the person's mouth is open or closed.

11. The operator behavior recognition system of claim 1, in which the classifier group is pre-trained with classifiers which takes as input the objects detected from the object detection group in combination with facial features extracted from the facial feature extraction group to classify the behavior of a person.

12. The operator behavior recognition system of claim 11, in which the classifier uses the position of the hand of a person in relation to the position of a mobile device in relation to the position of a face of a person in combination with the mouth state of a person, to determine if a person is talking on a mobile device.

13. The operator behavior recognition system of claim 11, in which the classifier uses the position of the hand of a person in relation to the position of a mobile device, to determine if a person is using a mobile device.

14. The operator behavior recognition system of claim 11, in which the classifier uses the position of the hand/hands of a person in relation to the position of predefined components/controls of a machine to determine if a person is operating the machine.

15. The operator behavior recognition system of claim 11, in which the classifier group includes classification techniques selected from any one of support vector machines (SVMs), neural networks, and boosted classification trees.

16. The operator behavior recognition system of claim 15, in which the classifier group includes two additional classifiers being:
a single image CNN of the operator;
a single image CNN of the operator in combination with a long-term-short-term memory (LSTM) recurrent network, which keeps a memory of a series of previous images.

17. The operator behavior recognition system of claim 16, in which the classifier group includes an ensemble function to ensemble the outputs of the classifiers together with the output of the single image CNN of the operator together with the combination of the single image CNN and the LSTM recurrent network by a weighted sum of the three classifiers where the weights are determined by optimizing the weights on the training dataset, the ensembled output from the classifiers being used to determine the operator behavior.

18. The operator behavior recognition system of claim 1, in which the set of CNNs in the object detection group, the facial feature extraction group and the classifier group is implemented on any one of a single set of hardware and on multiple sets of hardware.

19. A machine-implemented method for automated recognition of operator behavior, which includes:
receiving onto processing hardware at least one image from an image source;
processing the at least one image by an object detection group to detect at least one object in the image and to delineate the object from the image for further processing, at least one of the objects being detected being a face of a person;
processing a face object of a person by means of a facial features extraction group to extract facial features from the person's face, which includes determining the location of any one of the person's eyes, mouth, nose and jaw; and
processing an output from the object detection group and the facial features extraction group by means of a classifier group to assess the facial features received from the facial feature extraction group in combination with objects detected by the object detection group to classify predefined operator behaviors.

20. The machine-implemented method for automated recognition of operator behavior as claimed in claim 19, in which the step of processing the at least one image by an object detection group includes detecting objects in an image and delineating detected objects from the rest of the image.

21. The machine-implemented method for automated recognition of operator behavior as claimed in claim 20, in which the step of processing the at least one image by an object detection group includes recognizing any one or more of a hand of a person, an operator, predefined components/controls of a machine and a mobile device.

22. The machine-implemented method for automated recognition of operator behavior as claimed in claim 21, in which the step of processing the at least one image by an object detection group includes generating separate images each of which is a subset of the at least one image received from the image source.

23. The machine-implemented method for automated recognition of operator behavior as claimed in claim 22, in which the step of processing a face object of a person by means of the facial features extraction group includes recognizing a predefined facial expression of a person.

24. The machine-implemented method for automated recognition of operator behavior as claimed in claim 23, in which the step of processing a face object of a person by means of the facial features extraction group includes extracting any one or more of the face pose, the gaze direction, and the mouth state from an image of the person's face.

25. (canceled)

26. The machine-implemented method for automated recognition of operator behavior as claimed in claim 19, in which the step of processing a face object of a person by means of the facial features extraction group include determining if the person's mouth is open or closed.

27. The machine-implemented method for automated recognition of operator behavior as claimed in claim 26, in which the step of processing an output from the object detection group and the facial features extraction group by means of the classifier group includes taking as input the objects detected from the object detection group in combination with facial features extracted from the facial feature extraction group to classify the behavior of a person.

28. The machine-implemented method for automated recognition of operator behavior as claimed in claim 27, in which the step of processing an output from the object detection group and the facial features extraction group by means of the classifier group includes determining if a person is talking on a mobile device by using the position of the hand of a person in relation to the position of a mobile device in relation to the position of a face of the person in combination with the mouth state of the person.

29. The machine-implemented method for automated recognition of operator behavior as claimed in claim 28, in which the step of processing an output from the object detection group and the facial features extraction group by means of the classifier group includes implementing classification techniques which includes any one of support vector machines (SVMs), neural networks, and boosted classification trees, or other machine learning classifiers.

30. The machine-implemented method for automated recognition of operator behavior as claimed in claim 29, in which the step of processing an output from the object detection group and the facial features extraction group by means of the classifier group includes using two additional classifiers being:
a single image CNN of the operator;
a single image CNN of the operator in combination with a long-term-short-term memory (LSTM) recurrent network, which keeps a memory of a series of previous images.

31. The machine-implemented method for automated recognition of operator behavior as claimed in claim 30, in which the step of processing an output from the object detection group and the facial features extraction group by means of the classifier group includes ensembling the outputs of the classifiers together with the output of the single image CNN of the operator together with the combination of the single image CNN and the LSTM recurrent network by a weighted sum of the three classifiers where the weights are determined by optimizing the weights on the training dataset.

32. The machine-implemented method for automated recognition of operator behavior as claimed in claim 31, in which the step of processing an output from the object detection group and the facial features extraction group by means of the classifier group includes using the output from the classifiers to determine the operator behavior.

33. A machine-implemented method for training an operator behavior recognition system as claimed in claim 1, the method including:
providing a training database of input images and desired outputs;
dividing the training database into a training subset and a validation subset with no overlap between the training subset and the validation subset;
initializing the CNN model with its particular parameters;
setting network hyperparameters for the training;
processing the training data in an iterative manner until the epoch parameters are complied with; and
validating the trained CNN model until a predefined accuracy threshold is achieved.

34. The machine-implemented method for training an operator behavior recognition system as claimed in claim 33, in which the machine-implemented method for training an operator behavior recognition system includes training any one or more of an object detection CNN as described, a facial features extraction CNN as described and a classifier CNN as described, each of which is provided with a training database and a relevant CNN to be trained.
